(19) United States
(12) Patent Application Publication
(10) Pub. No.: US 2024/0362503 A1
(43) Pub. Date: Oct. 31, 2024

(54) DOMAIN TRANSFORMATION TO AN IMMERSIVE VIRTUAL ENVIRONMENT USING ARTIFICIAL INTELLIGENCE

(71) Applicant: International Business Machines Corporation, Armonk, NY (US)

(72) Inventors: Rahul Krishna PRASAD, White Plains, NY (US); Maja VUKOVIC, New York, NY (US); Michael S. GORDON, Croton on Hudson, NY (US); Kommy WELDEMARIAM, Ottawa (CA)

(21) Appl. No.: 18/308,671

(22) Filed: Apr. 27, 2023

(51) Int. Cl. G06N 5/022

(52) U.S. Cl. CPC G06N 5/022

(57) ABSTRACT

A domain transformation system may determine a source ontology for a source domain of a first environment. The source domain relates to a process performed in the first environment. The process may be transformed from the source domain to a target domain of a second environment, such as a virtual environment. The domain transformation system may determine a first portion of a target ontology for the target domain. The domain transformation system may generate, using a machine learning technique, a first embedding of the source ontology and a second embedding of the target ontology. The domain transformation system may generate a joint embedding based on the first embedding and the second embedding domain transformation system and may determine a second portion of the target ontology, based on the joint embedding, using a transfer learning technique. The domain transformation system may refine the target ontology using a neuro-symbolic artificial intelligence technique.

### BACKGROUND

The present invention relates to a domain transformation, and more specifically, to a domain transformation to an immersive virtual environment using artificial intelligence. An immersive virtual environment may refer to an artificial environment that replaces real-world surroundings such that a user suspends disbelief in a real environment and fully engages with components of the artificial environment. A virtual reality application may generate the immersive virtual environment.

### SUMMARY

In some implementations, a method comprising: determining a source ontology for a source domain of a first environment; determining a first portion of a target ontology for the target domain; generating, using one or more machine learning techniques, a first embedding of the source ontology and a second embedding of the target ontology; generating a joint embedding based on the first embedding and the second embedding; determining a second portion of the target ontology, based on the joint embedding, using a transfer learning technique; refining the first portion and the second portion of the target ontology using a neuro-symbolic artificial intelligence technique; and transforming the process from the source domain to the target domain based on the first portion and the second portion of the target ontology. The source domain relates to a process performed in the first environment. The process is to be transformed from the source domain to a target domain of a second environment. The second environment is a virtual environment.

In some implementations, a computer program product comprising: one or more computer readable storage media, and program instructions collectively stored on the one or more computer readable storage media, the program instructions comprising: program instructions to determine a source ontology for a source domain of a first environment; program instructions to determine a first portion of a target ontology for the target domain; program instructions to generate, using one or more first machine learning techniques, a first embedding of the source ontology and a second embedding of the target ontology; program instructions to generate a joint embedding based on the first embedding and the second embedding; program instructions to determine a second portion of the target ontology, based on the joint embedding, using one or more second machine learning techniques; and program instructions to provide information regarding the first portion and the second portion of the target ontology to enable a transformation of the process from the source domain to the target domain. The source domain relates to a process performed in the first environment. The process is to be transformed from the source domain to a target domain of a second environment. The second environment is an immersive virtual environment. The first embedding includes a first plurality of nodes representing a first plurality of concepts of the source ontology. The second embedding includes a second plurality of nodes representing a second plurality of concepts of the target ontology.

In some implementations, a system comprising: one or more devices configured to: determine a source ontology for a source domain of a first environment; program instructions to determine a first portion of a target ontology for the target domain; program instructions to generate, using one or more first machine learning techniques, a first embedding of the source ontology and a second embedding of the target ontology; program instructions to generate a joint embedding based on the first embedding and the second embedding; program instructions to determine a second portion of the target ontology, based on the joint embedding, using one or more second machine learning techniques; and providing information regarding the first portion and the second portion of the target ontology to enable a transformation of the process from the source domain to the target domain. The source domain relates to a process performed in the first environment. The process is to be transformed from the source domain to a target domain of a second environment. The second environment is an immersive virtual environment wherein the first embedding includes a first plurality of nodes representing a first plurality of concepts of the source ontology. The second embedding includes a second plurality of nodes representing a second plurality of concepts of the target ontology.

### BRIEF DESCRIPTION OF THE DRAWINGS

FIGS. 1A-1D are diagrams of an example implementation described herein.

FIG. 2 is a diagram of an example computing environment in which systems and/or methods described herein may be implemented.

FIG. 3 is a diagram of example components of one or more devices of FIGS. 1 and 2.

FIG. 4 is a flowchart of an example process associated with a domain transformation to an immersive virtual environment using artificial intelligence.

### DETAILED DESCRIPTION

The following detailed description of example implementations refers to the accompanying drawings. The same reference numbers in different drawings may identify the same or similar elements.

Existing processes and operations of an entity may be implemented in a real world environment (or via an online presence). The processes and operations may include website designs, real estate transactions, vehicle purchase transactions, among other examples. In some situations, the entity (e.g., a business) may desire to transform the processes and operations for implementation in an immersive virtual reality environment. Examples of such transformations may include transforming an organizational structure from a centralized organizational structure to a decentralized organizational structure (e.g., decentralized autonomous organization), transforming a data storage from a centralized data storage to virtual assets, transforming a payment infrastructure from a physical infrastructure (e.g., for cash, check, among other examples) to cryptocurrency wallets, and/or transforming an asset ownership from individually owned assets to non-fungible tokens (NFTs), among other examples. Transforming a data storage from a centralized data storage to virtual assets may include transforming the data storage from using a centralized server into a decentralized storage that utilizes multiple storage providers. The decentralized storage may be used to store virtual assets, such as cryptocurrency, digital art, digital land, among other examples.

As the entity transforms the processes and operations for implementation in the immersive virtual reality environment, domain models for such processes and operations may be become obsolete or inadequate with respect to the immersive virtual reality environment. In this regard, the processes and operations would need to be updated and re-envisioned for the immersive virtual reality environment. The processes and operations may be updated and re-envisioned based on an analysis of existing artifacts (e.g., information regarding the processes and operations).

As part of updating and re-envisioning the processes and operations, domain models for each of these transformations to the immersive virtual reality environment may be generated and validated. However, generating and validating the domain models for each of these transformations is subject to multiple issues. For example, generating and validating the domain models is challenging (e.g., technically complex), laborious, and expensive (e.g., time consuming). For instance, generating and validating the domain models is computationally expensive because generating and validating the domain models requires a substantial amount of storage space and/or requires a substantial amount of central processing unit cycles.

As a result of such issues, content (for the immersive virtual reality environment) is mostly created anew. Creating content in this manner dismisses existing knowledge and information regarding the processes and operations. Accordingly, creating content in this manner negatively affects a measure of completeness of the transformations with respect to the processes and operations.

The incompleteness of the processes and operations may subject the processes and operations to technical issues in the immersive virtual environment when the processes and operations are implemented in the immersive virtual environment. In other words, the processes and operations may malfunction in the immersive virtual environment. For example, the processes and operations may generate errors, may generate inconsistent results, may fail to execute, among other examples. Computing devices may be used to troubleshoot the technical issues. In some situations, troubleshooting the technical issues may occur multiples times and may be time consuming. Accordingly, troubleshooting the technical issues may consume computing resources, storage resources, network resources, among other resources.

Therefore, a need exists for improving and accelerating a process of defining domain models in the immersive virtual environment in a systematic and a comprehensive manner that considers the existing knowledge.

Implementations described herein provide solutions to overcome the above issues relating to generating and validating domain models, for existing processes, in a virtual environment (e.g., an immersive virtual environment). For example, implementations described herein are directed to transforming and transferring existing processes (of an entity) to the immersive virtual environment based on analysis of existing artifacts relating the process. For instance, implementations described herein are directed to transforming a source ontology of a real environment to a target ontology of the immersive virtual environment. In other words, the target ontology may be generated based on information regarding the source ontology.

As an example, implementations described herein are directed to transforming a real estate transaction in the real world environment to a real estate transaction performed in the immersive virtual environment. As another example, implementations described herein are directed to transforming a vehicle purchase transaction in the real world environment to a vehicle purchase performed in the immersive virtual environment.

The term “domain” may be used to refer to subject matter. The term “process” may include a transaction, an operation, a process, among other examples. The entity may be an individual, an organization, a business, among other examples. In some instances, the artifacts may include data, documents, files, logs, processes, libraries, and/or products, among other examples.

Implementations described herein utilize machine learning techniques to leverage and transform a domain knowledge (of existing one or more models for the process) into one or more models that are applicable to the immersive virtual environment. In some examples, implementations described herein are directed to determining a source ontology for a source domain and defining requisite components for the target ontology. For example, the source ontology may be defined or an existing source ontology may be explored and utilized. In some situations, determining the source ontology may include identifying and analyzing existing artifacts relating to the process.

Implementations described herein may further include enforcing constraints (e.g., domain transformation specification constraints) based on a rule-based approach in order to define critical transformations model components from the source domain to the target domain. As used herein, “domain transformation” may refer to generating the target ontology of the immersive virtual environment based on the source ontology of the real world environment. Implementations described may further include using a deep neural network (DNN)-based technique to learn embedding models from the source domain model (or from a source domain knowledge graph) and from the target domain model (or from a target domain knowledge graph).

Implementations described herein may further include generating a joint embedding of the source domain model and the target domain model by projecting the embedding models (from the source domain model and from the target domain model) onto a latent intermediate representation. Additionally, implementations described herein may include perform an artificial intelligence (AI)-guided knowledge graph imputation to predict concepts missing from a target ontology, to predict new relationships between components of the target ontology, and to discover new knowledge graph n-tuples (e.g., triples) that represent components of the target ontology.

Implementations described herein may additionally use the source domain model and the target domain model to perform transfer learning in order to infer base relationships between the source domain and the target domain. In some situations, implementations described herein may identify gaps and enhancements required for the enablement of the process (in the immersive virtual environment) based on principles of transfer learning. For example, implementation described herein may identify concepts (for the target domain) that did not exist in the source domain, may identify relationships between concepts (for the target domain) that did not exist in the source domain, among other examples.

The target ontology may be derived using a knowledge graph completion technique. The knowledge graph completion technique may be augmented using a neuro-symbolic AI technique. One advantage of implementations described herein is to defining domain models, in an immersive virtual environment, in a systematic and a comprehensive manner that considers existing knowledge of the source domain. Another advantage of implementations described herein is to preserve computing resources, network resources, and other resources that would have otherwise been used to troubleshoot the technical issues resulting from the process malfunctioning in the immersive virtual environment.

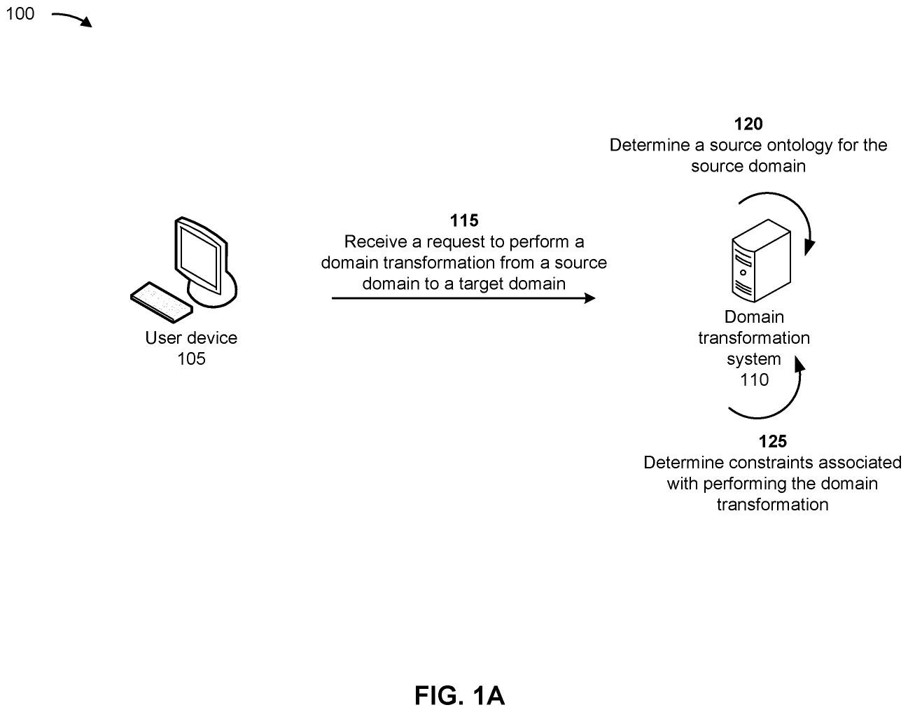

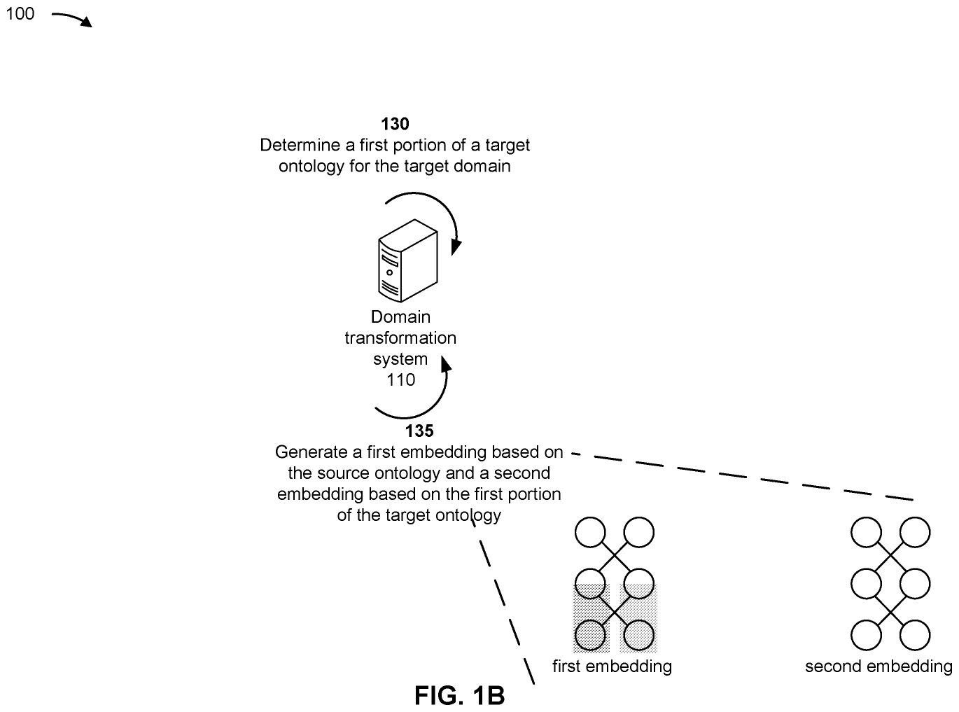

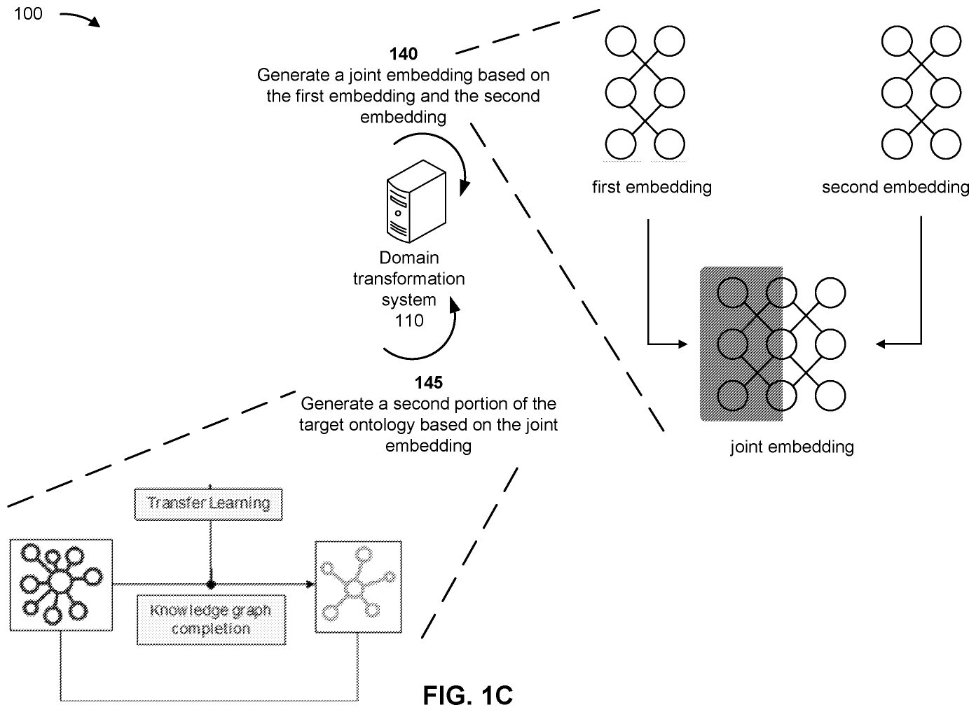

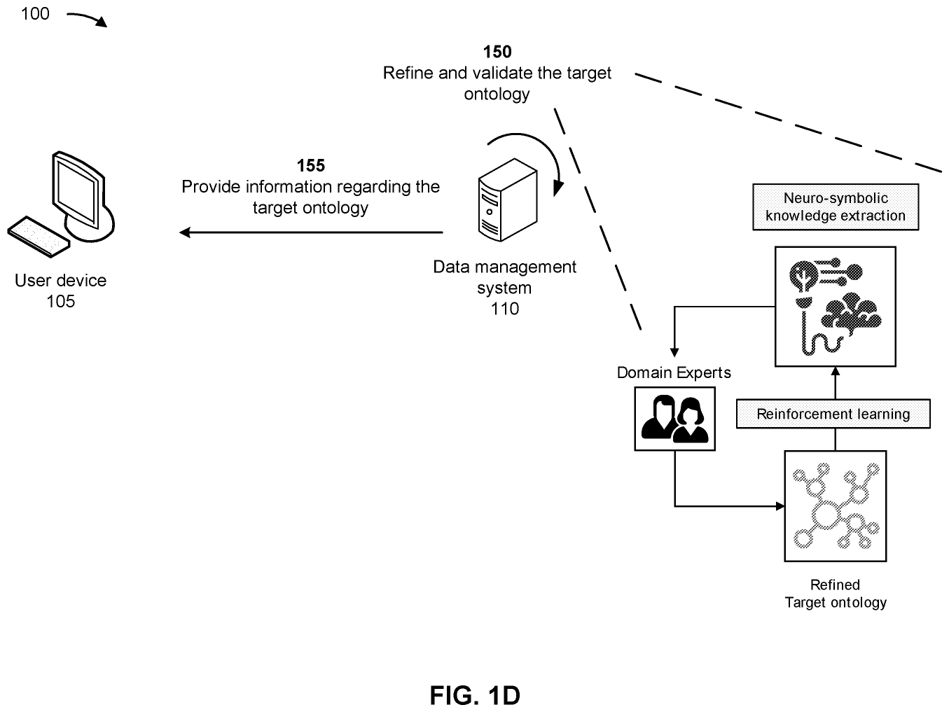

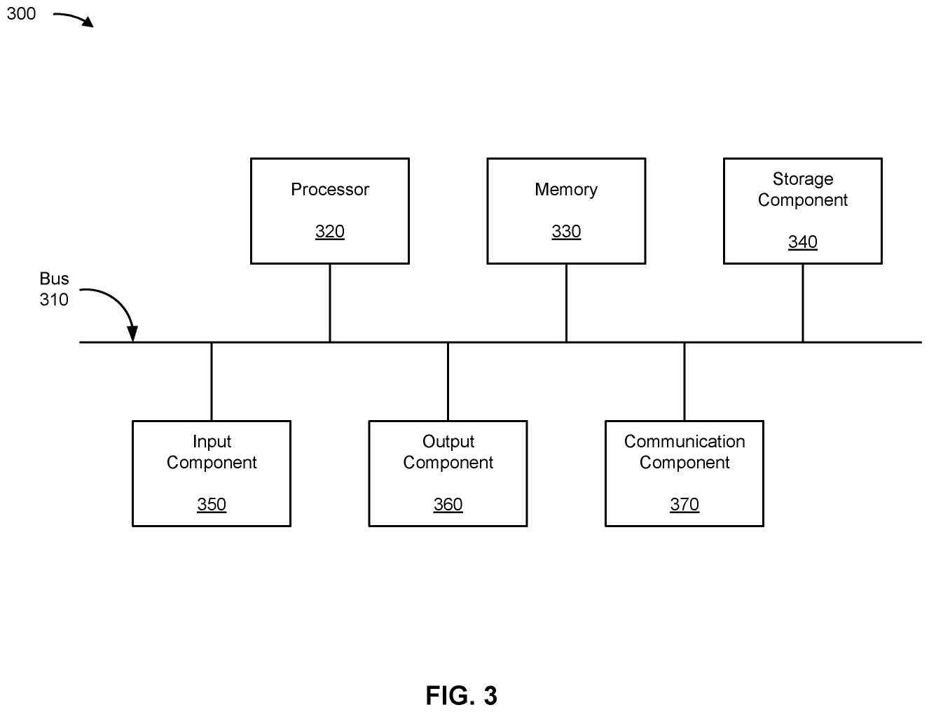

FIGS. 1A-1D are diagrams of an example implementation 100 described herein. As shown in FIGS. 1A-1D, example implementation 100 includes a user device 105 and a domain transformation system 110. These devices are described in more detail below in connection with FIG. 3.

User device 105 and domain transformation system 110 may be connected via wired connections, wireless connections, or a combination of wired and wireless connections. For example, user device 105 and domain transformation system 110 may be connected via a network that includes one or more wired and/or wireless networks. For example, the network may include Ethernet switches. Additionally, or alternatively, the network may include a cellular network, a public land mobile network (PLMN), a local area network (LAN), a wide area network (WAN), a private network, the Internet, and/or a combination of these or other types of networks. The network enables communication between user device 105, domain transformation system 110, and/or one or more additional devices associated with the domain transformation system 110.

User device 105 may include one or more devices configured to receive, generate, store, process, and/or provide information associated with a domain transformation to an immersive virtual environment using artificial intelligence, as explained herein. User device 105 may include a communication device and a computing device. For example, user device 105 may include a wireless communication device, a mobile phone, a user equipment, a laptop computer, a tablet computer, a desktop computer, or a similar type of device.

Domain transformation system 110 may include one or more devices configured to receive, generate, store, process, and/or provide information associated with a domain transformation to an immersive virtual environment using artificial intelligence, as explained herein. In some examples, management system 110 may be configured to generate and validate a target ontology of an immersive virtual reality based on a source ontology of a real world environment, as described herein.

As shown in FIG. 1B, and by reference number 115, domain transformation system 110 may receive a request to perform a domain transformation from a source domain to a target domain. For example, domain transformation system 110 may receive the request from user device 105. The source domain may be a domain of a real world environment and the target domain may be a domain of an immersive virtual environment. In some situations, user device 105 may be a device of an entity that performs an existing process in the real world environment. The entity may include a business, an organization, an individual, a group of individuals, among other examples.

The request may be provided by user device 105 in order to implement the existing process in the immersive virtual environment. As an example, the request may be provided to transform a real estate transaction in a real world environment to a real estate transaction performed in the immersive virtual environment. In such an instance, the source domain may relate to a real estate transaction in the real world environment. The target domain may relate to real estate transactions performed in the immersive virtual environment.

As another example, the request may be provided to transform a vehicle purchase transaction in the real world environment to a vehicle purchase performed in the immersive virtual environment. In such an instance, the source domain may relate to vehicle purchase transactions in the real world environment. The target domain may relate to vehicle purchase transactions performed in the immersive virtual environment.

As shown in FIG. 1B, and by reference number 120, domain transformation system 110 may determine a source ontology for the source domain. For example, based on receiving the request, domain transformation system 110 may determine the source ontology for the source domain. The source ontology may include information identifying components (e.g., concepts) of the source domain and identifying relationships between the components. In some examples, the source ontology may include information that may be used to understand topology of the source domain and understand data relating to the source domain.

In some implementations, as part of determining the source ontology, domain transformation system 110 may identify and analyze artifacts relating to the source domain. The artifacts may include computer code, text datasets, logs, configuration documents, data model(s), information regarding communications. In some examples, domain transformation system 110 may be configured to identify the artifacts based on historical data regarding artifacts and/or types of artifacts that have been previously identified for other source domains.

As part of identifying and analyzing the artifacts, domain transformation system 110 may perform masking of a portion of the artifacts, may redact a portion of the artifacts, and/or may perform data labeling on the artifacts. As a result of analyzing the artifacts, domain transformation system 110 may identify information that may enable domain transformation system 110 to determine the source ontology. Additionally, or alternatively, domain transformation system 110 may determine a topology of concepts of the source ontology.

In some implementations, as part of determining the source ontology, domain transformation system 110 (and/or user device 105) defines the source ontology for the source domain and/or defines a knowledge base for the source domain. For example, domain transformation system 110 may define the source ontology based on analyzing the artifacts. some implementations, as part of determining the source ontology, domain transformation system 110 (and/or user device 105) may utilize an existing ontology for the source domain. In some situations, domain transformation system 110 may modify the existing ontology (e.g., based on analyzing the artifacts) to generate the source ontology.

In the context of a real estate transaction in the real world environment, as an example, the real estate transaction may be modeled as an ontology representing various actors for the real estate transaction, actions of the actors, and relationships between the actors (and/or other actors) and the actions. The resulting ontological model may aim to capture all complex steps and concepts related to the real estate transaction.

The ontology for the real-estate transaction may be modeled as an interaction between several discrete domain concepts and categories such as a first category (e.g., a person category), a second category (e.g., a transaction category), and a third category (e.g., a category relating to a location, contract, legal, and organization). The first category may include a buyer, a seller, a real estate agent, among other examples, as well as jurisdictional and civil entities such as persons representing enterprises such as banks, or public administrators. The first category may include several relationships such as ‘is_buyer’ (e.g., person is a buyer), ‘is_seller’ (e.g., person is a seller), ‘buys_from’ (e.g., person buys from), ‘sells_to’ (e.g., person sells to), ‘has_residence’ (e.g., person has residence), among other examples.

The second category may include main concepts pertaining to real-estate transactions such as buy (representing the action of buying) and sell (representing the action of selling.). The concepts may cause relationships such as ‘is_bought’, ‘is sold’, ‘based_on’ (tax, legislation, jurisprudence), ‘acquires’, ‘verifies’ and ‘uses’.

The third category may include several other domain concepts related to a location (such as school district, county, street, etc.) associated with the real estate transaction, a contract associated with the real estate transaction, taxes associated with the real estate transaction, legal concepts associated with the real estate transaction (e.g., tax district, property tax, contract documentation and agreements), and organizational concepts associated with the real estate transaction (e.g., a bank, a loan amount, a loan duration, a down payment, among other examples).

In some implementations, as part of determining the source ontology, domain transformation system 110 may generate a source knowledge graph of text and relationships between components of the source ontology.

As shown in FIG. 1B, and by reference number 125, domain transformation system 110 may determine constraints associated with performing the domain transformation. In some situations, domain transformation system 110 may receive information regarding the constraints. The information may be received from devices of one or more users (e.g., subject matter experts).

The subject matter experts may provide constraints (e.g., domain transformation specification constraints) that are based on a rule-based approach. The constraints may define transformations and components from the source domain to the target domain that may be required for the processes and operations (of the source domain) to be properly implemented in the target domain. As an example, the constraints may indicate that physical assets must be replaced by avatars in the immersive environment. The constraints may be enforced during the domain transformation.

As shown in FIG. 1B, and by reference number 130, domain transformation system 110 may determine a first portion of a target ontology for the target domain. The first portion of the target ontology may be an incomplete target ontology. In some situations, domain transformation system 110 may receive (as part of the request from user device 105) information that may be used to determine the portion of the target ontology. The information may correspond to initial requirements desired by the entity for the target domain (and/or for the target ontology). In some examples, the initial requirements may be based on concepts of the source domain and/or based on relationships between the concepts.

In some implementations, domain transformation system 110 may determine the first portion of the target ontology based on the constraints. In some situations, as part of determining the first portion of the target ontology, domain transformation system 110 may generate a target knowledge graph for the first portion of the target ontology. The target knowledge graph may be an incomplete knowledge graph for the target ontology.

As shown in FIG. 1B, and by reference number 135, domain transformation system 110 may generate a first embedding based on the source ontology and a second embedding based on the first portion of the target ontology. For example, after determining the source ontology and the target ontology, domain transformation system 110 may generate the first embedding and the second embedding. For instance, domain transformation system 110 may generate the first embedding based on concepts and relationships between concepts of the source ontology. Similarly, domain transformation system 110 may generate the second embedding based on concepts and relationships between concepts of the target ontology. The ontologies may be transformed into embeddings that include a plurality of nodes, with each node and relationships associated with the node receiving an embedding vector to define a respective content (e.g., define information regarding the concept and interconnections with other concepts).

As an example, when generating the first embedding, components of the source ontology may be transformed into triples. Each triple may include a subject, a predicate, and an object. For instance, with respect to the real-estate transaction, a first triple may be <person, is_associated, organization>, a second triple may be <person, has_residence, location>, among other examples.

Domain transformation system 110 may use embedding techniques to project (or convert) the triples, of the source ontology, into n-dimensional vector space representations. In other words, domain transformation system 110 may generate vectors based on the triples. Each vector may be associated with a numerical representation. Each triple may have a vector representation which provides information regarding the triple. Each triple may represent a concept. In some examples, each node (of the first embedding) may be associated with a vector [symbol] ⁿ and each relation name [symbol] is associated with a scoring function as follows:

$${s}_{} : {ℝ}^{n} \times {ℝ}^{n} \to ℝ \qquad ( 1 )$$

The scoring function may encode information about the likelihood of the triples. In some examples, generating the first embedding may enable inference of facts about the source domain. For example, if <person, is_associated, organization> and <person, has_residence, location>, then domain transformation system 110 may infer that <organization, has_residence, location>.

In some examples, the first embedding may identify concepts that are similar, identify concepts that are dissimilar, and identify new relationships between the concepts. For example, two concepts that are similar may be within a threshold distance of each other with respect to a distance between the two concepts. Conversely, two concepts that are dissimilar may be far more than the threshold distance of each other with respect to a distance between the two concepts.

Domain transformation system 110 may generate the second embedding in a manner similar to a manner in which the first embedding is generated. For example, components of the target ontology may be transformed into triples and the triples may be transformed into vectors. In some examples, a numerical value, of a vector representing a concept of the first embedding, may be different than a numerical value of a vector representing the same concept of the second embedding.

In some situations, domain transformation system 110 may generate the embeddings using a natural language processing technique. Additionally, or alternatively, domain transformation system 110 may generate the embeddings using a machine learning technique,

As shown in FIG. 1C, and by reference number 140, domain transformation system 110 may generate a joint embedding based on the first embedding and the second embedding. For example, after generating the first embedding and the second embedding, domain transformation system 110 may project the vectors of the first embedding and of the second embedding into a common intermediate latent space. For instance, domain transformation system 110 may combine structural and literal vectors (or embedding vectors) into joint embedding vectors using a translation mechanism of one or more embedding techniques.

In some situations, domain transformation system 110 may use a hidden and tunable weighting function to project the n-dimensional vectors (of the source ontology and of the target ontology) to a common intermediate space. Domain transformation system 110 may utilize techniques that allow embedded vectors, from multiple domains, to be transformed (or modified) to intermediate representations.

As an example, a first numerical value (of a first concept of the source ontology) may be different than a second numerical value (of the first concept of the target ontology). A third numerical value (of the first concept) may different than the first numerical value and the second numerical value.

Based on the foregoing, domain transformation system 110 may generate a latent, disentangled intermediate representation (or IR) that jointly embeds mutual information in the source ontology and in the target ontology. This joint embedding may enable efficiently transfer knowledge from the source ontology to the target ontology.

As shown in FIG. 1C, and by reference number 145, domain transformation system 110 may generate a second portion of the target ontology based on the joint embedding. By generating the second portion of the target ontology, domain transformation system 110 may generate a complete target ontology (instead of a partial target ontology). In some examples, the second portion of the target ontology may be generated using a transfer learning technique and using an imputation technique (e.g., an ontology imputation technique). In other words, domain transformation system 110 may complete the second portion of the target ontology using the joint intermediate latent representation and using various knowledge graph imputation techniques.

The knowledge graph imputation techniques may involve 3 sub-components that operate in conjunction: 1) entity prediction; 2) relationship prediction; and 3) triplet classification. For example, domain transformation system 110 may use entity prediction to discover new concepts in the target domain. As an example, domain transformation system 110 may use a knowledge graph or a knowledge graph embedding model to discover the new concepts. For instance, domain transformation system 110 may identify a concept that has appeared in the source domain but are missing in the target domain. Domain transformation system 110 may use a relationship prediction technique to discover new relationships between existing concepts that were included in the source domain but not yet available in the target domain. For example, domain transformation system 110 may use a linear regression model to discover the new relationships.

Domain transformation system 110 may use a triple classification technique to discover entirely new triples that have not been modeled in the source domain but are highly likely to be part of the target domain. Based on the foregoing, domain transformation system 110 may enable a comprehensive transfer of knowledge from the source ontology to the target ontology.

As shown in FIG. 1D, and by reference number 150, domain transformation system 110 may refine and validate the target ontology. For example, the target ontology may be refined and validated using a subject matter expert driven refinement approach. Such approach may be enabled by leveraging a neuro-symbolic artificial intelligence technique, such as a neuro-symbolic query answering mechanism. For instance, the subject matter experts may interact with the target ontology by providing queries using one or more computing devices. The queries may be automatically derived using a neuro-symbolic knowledge extraction technique.

The target ontology may be used (e.g., by domain transformation system 110) to provide answers to the queries. The subject matter experts may provide feedback regarding a measure of quality of the query and/or regarding a measure of quality of the answer. The feedback may be used (e.g., by domain transformation system 110) to refine the target ontology in order to improve the fidelity of the answers. In some instances, the subject matter experts may provide feedback on potential rules that can be derived from the target ontology. In this regard, implementations described provide a method for enabling crowdsourcing for expanding the target ontology and for supporting multiple user experiences in the artifacts transformed to the immersive virtual environment.

As shown in FIG. 1D, and by reference number 155, domain transformation system 110 may provide information regarding the target ontology. For example, after refining and validating the target ontology, domain transformation system 110 may provide the information regarding the target ontology to user device 105. The information may be provided as a response to the request received from user device 105. The information may be provided as a knowledge graph of the target ontology. In some implementations, domain transformation system 110 may transform the process from the source domain to the target domain based on the first portion and the second portion of the target ontology.

Implementations described herein are directed to automating and accelerating a process of generating such a target ontology, for an immersive virtual environment, by using a transfer learning-based approach described. Implementations described herein provide a manner to validate and evolve the artifacts and the target ontology through user feedback (e.g., measuring the value or importance of data, documents, files, logs, processes, etc.). Implementations described identify gaps and enhancements required for an enablement of the source domain and the source ontology in the immersive environment based on principles of transfer learning.

While examples of transformations have been described above, implementations described herein are directed to migrating business models, of e-commerce providers, to the immersive virtual environment in order to transact with (or in) digital assets, transforming models for a no-code website design models to a no-code asset design model in the immersive virtual environment to enable no effort content creation, transforming shopping from brick-and-mortar shops to transactions in the immersive virtual environment, transferring press briefing artifacts and processes to organizing a press briefing in the immersive virtual environment. With respect to transforming models for a no-code website design models to a no-code asset design model, implementations described herein may transform drag-and-drop building blocks and templates for website designing to corresponding elements in the immersive virtual environment in a manner similar to the manner described herein with respect transformations. For example, implementations described herein may transform drag-and-drop tools for website designing to corresponding tools in the immersive virtual environment in a manner similar to the manner described herein with respect to transformations.

One advantage of implementations described herein is to define domain models, in an immersive virtual environment, in a systematic and a comprehensive manner that considers existing knowledge of the source domain. Another advantage of implementations described herein is to preserve computing resources, storage resources, network resources, and other resources that would have otherwise been used to troubleshoot the technical issues resulting from the process malfunctioning in the immersive virtual environment. For example, implementations described herein eliminate computational cycles that would have otherwise been used to troubleshoot the technical issues. Additionally, implementations described herein eliminate a substantial amount of storage space that would have otherwise been used to troubleshoot the technical issues. Additionally, implementations described herein eliminate a substantial amount of network bandwidth that would have otherwise been used to troubleshoot the technical issues.

As indicated above, FIGS. 1A-1D are provided as an example. Other examples may differ from what is described with regard to FIGS. 1A-1D. The number and arrangement of devices shown in FIGS. 1A-1D are provided as an example. A network, formed by the devices shown in FIGS. 1A-1D may be part of a network that comprises various configurations and uses various protocols including local Ethernet networks, private networks using communication protocols proprietary to one or more companies, cellular and wireless networks (e.g., Wi-Fi), instant messaging, Hypertext Transfer Protocol (HTTP) and simple mail transfer protocol (SMTP), and various combinations of the foregoing.

There may be additional devices (e.g., a large number of devices), fewer devices, different devices, or differently arranged devices than those shown in FIGS. 1A-1D. Furthermore, two or more devices shown in FIGS. 1A-1D may be implemented within a single device, or a single device shown in FIGS. 1A-1D may be implemented as multiple, distributed devices. Additionally, or alternatively, a set of devices (e.g., one or more devices) shown in FIGS. 1A-1D may perform one or more functions described as being performed by another set of devices shown in FIGS. 1A-1D.

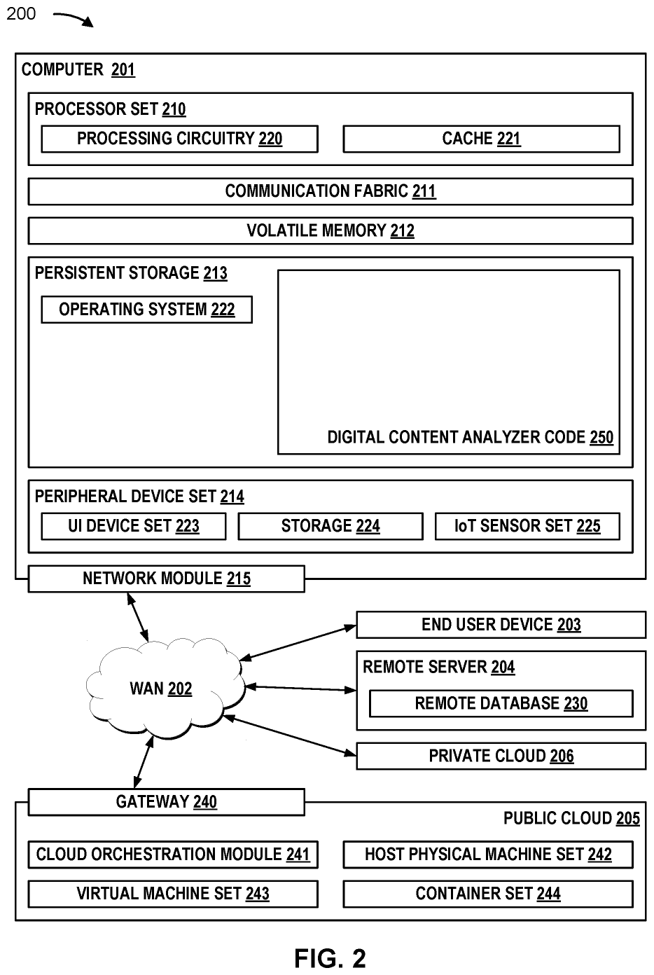

FIG. 2 is a diagram of an example computing environment 200 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200 contains an example of an environment for the execution of at least some of the computer code involved in performing the inventive methods, such as digital content analyzer code 250. In addition to block 250, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and block 250, as identified above), peripheral device set 214 (including user interface (UI) device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

COMPUTER 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

PROCESSOR SET 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in block 250 in persistent storage 213.

COMMUNICATION FABRIC 211 is the signal conduction path that allows the various components of computer 201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 212 is any type of volatile memory now known or to be developed in the future. Examples include dynamic type random access memory (RAM) or static type RAM. Typically, volatile memory 212 is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

PERSISTENT STORAGE 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re- writing of data. Some familiar forms of persistent storage include magnetic disks and solid state storage devices. Operating system 222 may take several forms, such as various known proprietary operating systems or open source Portable Operating System Interface-type operating systems that employ a kernel. The code included in block 250 typically includes at least some of the computer code involved in performing the inventive methods.

PERIPHERAL DEVICE SET 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

NETWORK MODULE 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN 202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 203 is any computer system that is used and controlled by an end user (for example, a customer of an enterprise that operates computer 201) and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

REMOTE SERVER 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

PUBLIC CLOUD 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

FIG. 3 is a diagram of example components of a device 300, which may correspond to user device 105 and/or domain transformation system 110. In some implementations, user device 105 and/or domain transformation system 110 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

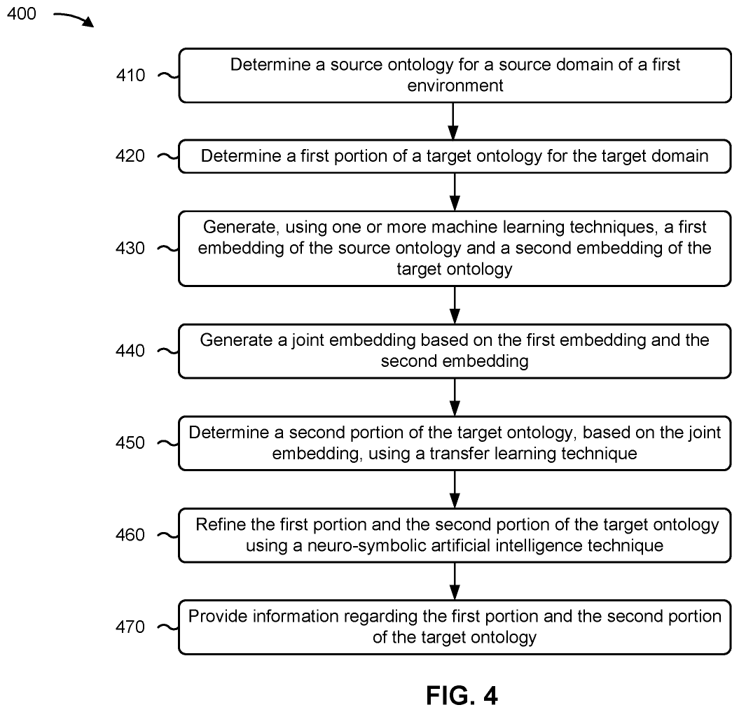

FIG. 4 is a flowchart of an example process 400 associated with domain transformation to an immersive virtual environment. In some implementations, one or more process blocks of FIG. 4 may be performed by a domain transformation system (e.g., domain transformation system 110). In some implementations, one or more process blocks of FIG. 4 may be performed by another device, or a group of devices separate from or including the domain transformation system, such as a user device (e.g., user device 105). Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include determining a source ontology for a source domain of a first environment, wherein the source domain relates to a process performed in the first environment, wherein the process is to be transformed from the source domain to a target domain of a second environment, and wherein the second environment is a virtual environment (block 410). For example, the domain transformation system may determine a source ontology for a source domain of a first environment, wherein the source domain relates to a process performed in the first environment, wherein the process is to be transformed from the source domain to a target domain of a second environment, and wherein the second environment is a virtual environment, as described above. In some implementations, the source domain relates to a process performed in the first environment, wherein the process is to be transformed from the source domain to a target domain of a second environment, and wherein the second environment is a virtual environment.

As further shown in FIG. 4, process 400 may include determining a first portion of a target ontology for the target domain (block 420). For example, the domain transformation system may determine a first portion of a target ontology for the target domain, as described above.

As further shown in FIG. 4, process 400 may include generating, using one or more machine learning techniques, a first embedding of the source ontology and a second embedding of the target ontology (block 430). For example, the domain transformation system may generate, using one or more machine learning techniques, a first embedding of the source ontology and a second embedding of the target ontology, as described above.

As further shown in FIG. 4, process 400 may include generating a joint embedding based on the first embedding and the second embedding (block 440). For example, the domain transformation system may generate a joint embedding based on the first embedding and the second embedding, as described above.

As further shown in FIG. 4, process 400 may include determining a second portion of the target ontology, based on the joint embedding, using a transfer learning technique (block 450). For example, the domain transformation system may determine a second portion of the target ontology, based on the joint embedding, using a transfer learning technique, as described above.

As further shown in FIG. 4, process 400 may include the first portion and the second portion of the target ontology using a neuro-symbolic artificial intelligence technique (block 460). For example, the domain transformation system may refine the first portion and the second portion of the target ontology using a neuro-symbolic artificial intelligence technique, as described above.

As further shown in FIG. 4, process 400 may include providing information regarding the first portion and the second portion of the target ontology to enable a transformation of the process from the source domain to the target domain (block 470). For example, the domain transformation system may provide information regarding the first portion and the second portion of the target ontology to enable a transformation of the process from the source domain to the target domain, as described above. In some implementations, the domain transformation system may transform the process from the source domain to the target domain based on the first portion and the second portion of the target ontology.

In some implementations, process 400 includes identifying source domain information regarding the source domain, wherein the source domain information is identified using one or more machine learning models, and wherein the source domain information includes data, documents, files, logs, process, libraries, and products, analyzing source domain information regarding the source domain, and determining the source ontology based on analyzing the source domain information.

In some implementations, generating the first embedding and the second embedding comprises generating the first embedding and the second embedding using a natural language processing technique.

In some implementations, providing the information regarding the first portion and the second of the target ontology comprises generating a knowledge graph based on the first portion and the second portion of the target ontology, and providing the knowledge graph.

In some implementations, the first embedding includes a plurality of nodes, and wherein each node, of the plurality of nodes, represents a concept of the source ontology and is associated with a vector that defines the concept.

In some implementations, determining the second portion comprises determining the second portion of the target ontology, based on the joint embedding, using an imputation technique.

In some implementations, process 400 includes determining constraints associated with transforming the process from the source domain to the target domain of the second environment, and wherein determining the first portion of the target ontology comprises including, in the first portion of the target ontology, information regarding the constraints to cause the constraints to be enforced when the process is transformed from the source domain to the target domain.

In some implementations, process 400 includes identifying a first vector for a first component of the source ontology; identifying a second vector for a second component of the source ontology; and determining a similarity (e.g., similarity probability) between the first component and the second component based on the first vector and the second vector. Determining the second portion of the target ontology comprises including, in the second portion of the target ontology, the first component, the second component, and information indicating the similarity between the first component and the second component.

In some implementations, process includes receiving information indicating one or more changes with respect to concepts of the source ontology; and updating one or more corresponding concepts of the target ontology based on receiving the information indicating the one or more changes.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method comprising:
determining a source ontology for a source domain of a first environment,
wherein the source domain relates to a process performed in the first environment,
wherein the process is to be transformed from the source domain to a target domain of a second environment that is a virtual environment;
determining a first portion of a target ontology for the target domain;
generating, using one or more machine learning techniques, a first embedding of the source ontology and a second embedding of the target ontology;
generating a joint embedding based on the first embedding and the second embedding;
determining a second portion of the target ontology, based on the joint embedding, using a transfer learning technique;
refining the first portion and the second portion of the target ontology using a neuro-symbolic artificial intelligence technique; and
transforming the process from the source domain to the target domain based on the first portion and the second portion of the target ontology.

2. The computer-implemented method of claim 1, further comprising:
identifying source domain information regarding the source domain,
wherein the source domain information is identified using one or more machine learning models, and
wherein the source domain information includes data, documents, files, logs, process, libraries, and products;
analyzing source domain information regarding the source domain; and
determining the source ontology based on analyzing the source domain information.

3. The computer-implemented method of claim 1, wherein generating the first embedding and the second embedding comprises:
generating the first embedding and the second embedding using a natural language processing technique.

4. The computer-implemented method of claim 1, wherein providing the information regarding the first portion and the second of the target ontology comprises:
generating a knowledge graph based on the first portion and the second portion of the target ontology; and
providing the knowledge graph.

5. The computer-implemented method of claim 1, wherein the first embedding includes a plurality of nodes, and
wherein each node, of the plurality of nodes, represents a concept of the source ontology and is associated with a vector that defines the concept.

6. The computer-implemented method of claim 5, wherein determining the second portion comprises:
determining the second portion of the target ontology, based on the joint embedding, using an imputation technique.

7. The computer-implemented method of claim 1, further comprising:
determining constraints associated with transforming the process from the source domain to the target domain of the second environment; and
wherein determining the first portion of the target ontology comprises:
including, in the first portion of the target ontology, information regarding the constraints to cause the constraints to be enforced when the process is transformed from the source domain to the target domain.

8. A computer program product comprising:
one or more computer readable storage media, and program instructions collectively stored on the one or more computer readable storage media, the program instructions comprising:
program instructions to determine a source ontology for a source domain of a first environment,
wherein the source domain relates to a process performed in the first environment, wherein the process is to be transformed from the source domain to a target domain of a second environment, and wherein the second environment is an immersive virtual environment;
program instructions to determine a first portion of a target ontology for the target domain;
program instructions to generate, using one or more first machine learning techniques, a first embedding of the source ontology and a second embedding of the target ontology,
wherein the first embedding includes a first plurality of nodes representing a first plurality of concepts of the source ontology, and wherein the second embedding includes a second plurality of nodes representing a second plurality of concepts of the target ontology;
program instructions to generate a joint embedding based on the first embedding and the second embedding;
program instructions to determine a second portion of the target ontology, based on the joint embedding, using one or more second machine learning techniques; and
program instructions to provide information regarding the first portion and the second portion of the target ontology to enable a transformation of the process from the source domain to the target domain.

9. The computer program product of claim 8, wherein the program instructions further comprise:
program instructions to refine the first portion and the second portion of the target ontology using a neuro-symbolic artificial intelligence technique; and
program instructions to validate the first portion and the second portion of the target ontology using the neuro-symbolic artificial intelligence technique.

10. The computer program product of claim 8, wherein a first plurality of nodes, of the first embedding, are associated with a first plurality of vectors,
wherein a second plurality of nodes, of the second embedding, are associated with a second plurality of vectors,
wherein the program instructions to program instructions to generate the joint embedding comprise:
program instructions to combine the first plurality of nodes and the second plurality of nodes to generate a third plurality of nodes.

11. The computer program product of claim 8, wherein the target ontology identify one or more first concepts,
wherein the program instructions to program instructions to determine the second portion of the target ontology comprise:
program instructions to identify one or more second concepts as part of the second portion of the target ontology,
wherein the one or more second concepts are not included in the first portion of the target ontology.

12. The computer program product of claim 11, wherein the program instructions to program instructions to determine the second portion of the target ontology comprise:
program instructions to determine one or more relationships between the one or more second concepts; and
program instructions to include information regarding the one or more relationship in the second portion of the target ontology.

13. The computer program product of claim 8, wherein the program instructions further comprise:
program instructions to detect one or more changes with respect to concepts of the source ontology; and
program instructions to update one or more corresponding concepts of the target ontology based on detecting the one or more changes.

14. The computer program product of claim 8, wherein the program instructions to determine the second portion comprise:
program instructions to determine the second portion of the target ontology, based on the joint embedding, using a transfer learning technique.

15. A system comprising:
one or more devices configured to:
determine a source ontology for a source domain of a first environment,
wherein the source domain relates to a process performed in the first environment, wherein the process is to be transformed from the source domain to a target domain of a second environment, and wherein the second environment is an immersive virtual environment;
determine a first portion of a target ontology for the target domain;
generate, using one or more first machine learning techniques, a first embedding of the source ontology and a second embedding of the target ontology,
wherein the first embedding includes a first plurality of nodes representing a first plurality of concepts of the source ontology, and wherein the second embedding includes a second plurality of nodes representing a second plurality of concepts of the target ontology;
generate a joint embedding based on the first embedding and the second embedding;
determine a second portion of the target ontology, based on the joint embedding, using one or more second machine learning techniques; and
provide information regarding the first portion and the second portion of the target ontology to enable a transformation of the process from the source domain to the target domain.

16. The system of claim 15, wherein the one or more devices are further configured to:
receive information indicating one or more changes with respect to concepts of the source ontology; and
update one or more corresponding concepts of the target ontology based on receiving the information indicating the one or more changes.

17. The system of claim 15, wherein the first embedding includes a plurality of nodes, and
wherein each node, of the plurality of nodes, represents a concept of the source ontology and is associated with a vector that defines the concept.

18. The system of claim 17, wherein the one or more devices are further configured to:
identify a first vector for a first component of the source ontology;
identify a second vector for a second component of the source ontology;
determine a similarity between the first component and the second component based on the first vector and the second vector; and
wherein, to determine the second portion of the target ontology, the one or more devices are further configured to:
include, in the second portion of the target ontology, the first component, the second component, and information indicating the similarity between the first component and the second component.

19. The system of claim 17, wherein the one or more devices are further configured to:
determine a first vector for a first component of the source ontology;
determine a second vector for a second component of the source ontology;
identify a third component for the source ontology based on the first vector and the second vector; and
wherein, to determine the second portion of the target ontology, the one or more devices are further configured to:
include the third component in the second portion of the target ontology.

20. The system of claim 15, wherein the one or more devices are further configured to:
validate the first portion and the second portion of the target ontology using a neuro-symbolic artificial intelligence technique.
